(19) United States
(12) Patent Application Publication
(10) Pub. No.: US 2009/0161168 A1
(43) Pub. Date: Jun. 25, 2009

(54) SOFTWARE, CONTROL APPARATUS AND CONTROLLING METHOD

(75) Inventor: Yoshio MIYAMOTO, Tokyo (JP)

Correspondence Address: FRISHAUF, HOLTZ, GOODMAN & CHICK, P.C., 16th Floor, 220 fifth Avenue, New York, NY, 10001-7708, US

(73) Assignee: Konica Minolta Business Technologies, Inc., Tokyo (JP)

(21) Appl. No.: 12/334,785

(22) Filed: Dec. 15, 2008

(30) Foreign Application Priority Data
Dec. 21, 2007 (JP) JP2007-330205

(51) Int. Cl. H04N 1/32

(52) U.S. Cl. 358/442

(57) ABSTRACT

There is described a control apparatus, which makes it possible to improve maneuverability of operations for setting the sender information in the facsimile system in which a facsimile apparatus and the control apparatus are coupled to each other through a network, so that the control apparatus instructs the facsimile apparatus to conduct a facsimile transmitting operation. The control apparatus includes: a sender information acquiring section to acquire from the facsimile apparatus at least one set of sender information, each of which is information about a sender and is registered in the facsimile apparatus in advance; and a sender information selecting section to allow a user to select one of the sender information from the acquired sender information displayed on a display section.

This application is based on Japanese Patent Application NO. 2007-330205 filed on Dec. 21, 2007, with Japan Patent Office, the entire content of which is hereby incorporated by reference.

### BACKGROUND OF THE INVENTION

The present invention relates to software, a control apparatus and a controlling method, each of which is to be operated in a control apparatus for controlling a facsimile apparatus.

There has been proliferated in the market an apparatus having a facsimile function for transmitting an image through the public telephone line (hereinafter, referred to as a FAX apparatus). For this purpose, in an office environment, the FAX apparatus is coupled to a user terminal device (hereinafter, referred to as a control apparatus) through a communication network, such as a LAN (Local Area Network), WAN (Wide Area Network), etc. When conducting a facsimile transmission through such the communication network, the operator at the sender side operates the control apparatus to create document data, and then, conducts operations for setting the receiver of the created document data, contents to be filled in the cover sheet of the facsimile document concerned, etc., by executing software installed in advance in the control apparatus concerned.

The cover sheet is filled with a name of the sender, a facsimile number, a title of the facsimile transmission, etc. Further, in addition to the above, it is possible for the operator at the sender side to attach specific information, including a section or a post of the sender, a name of the operator at the sender side, a facsimile (telephone) number, etc., to the cover sheet concerned, so that the user who receives the facsimile document can distinguish the specific site from which the facsimile document is transmitted.

For instance, Tokkaihei 11-252304 (Japanese Non-Examined Patent Publication) sets forth such a facsimile server that conducts a controlling operation for attaching the registered sender information to the cover sheet when the sender information is registered in advance, while, attaching the other sender information, based on the transmission instructing information sent from the data processing apparatus, to the cover sheet when the sender information is not currently registered.

In this connection, it is possible not only to register plural sets of sender information into the FAX apparatus, but also to select a desired one of sender information from the plural sets of sender information so as to attached the desired one to the cover sheet when the facsimile transmitting operation is conducted by directly operating the FAX apparatus itself. On the other hand, when the facsimile transmitting operation is conducted under the controlling operations conducted by the control apparatus, such the sender information that is established in advance as default settings among the plural sets of sender information registered in advance in the FAX apparatus is attached to the cover sheet. Accordingly, when attaching another sender information other than the default one to the cover sheet, the operator at the sender side should change the default settings of the sender information concerned by operating the operation section of the FAX apparatus, or otherwise, should input again the newly desired sender information by operating the operating section of the FAX apparatus.

To change the default settings of the sender information by operating the operating section of the FAX apparatus, however, it is necessary for the user not only to physically go to the FAX apparatus at the time when the user intends to transmit the facsimile document, but also to operate the unfamiliar operating section, resulting in an increase of cumbersome works. In addition, since the FAX apparatus is generally used by a plurality of users in a normal office environment, if a certain user has changed the default settings of the sender information to other settings unique for the user concerned, another user would erroneously send another facsimile document, on the cover sheet of which the sender information based on the settings other than the default settings are still attached, without recognizing the fact that the certain user previously has changed the default settings of the sender information to the other settings. Further, when plural FAX apparatuses are coupled to the communication network, sometimes, there would happen such a case that the user has taken another FAX apparatus, instead of the one for which the user intends to change the default settings of the sender information, by mistake.

Further, when inputting the sender information by operating the operating section of the control apparatus, the user should input again the sender information, which is already registered by the user, resulting in complicated operations. Specifically, it is indispensable for the user who frequently conducts the facsimile transmissions to input the sender information every time when he intends to send a facsimile document.

### SUMMARY OF THE INVENTION

To overcome the abovementioned drawbacks in conventional image forming apparatus, it is one of objects of the present invention to provide software, a control apparatus and a controlling method, each of which makes it possible to improve maneuverability of operations for setting the sender information.

Accordingly, at least one of the objects of the present invention can be attained by the controlling method described as follows.
(1) According to a controlling method reflecting an aspect of the present invention, the controlling method to be employed in such a system that includes a facsimile apparatus and a control apparatus for instructing the facsimile apparatus to conduct a facsimile transmitting operation, which are coupled to each other through a communication network, comprises: registering at least one set of sender information into the facsimile apparatus, each set of the sender information being information about a sender; transmitting the sender information registered in the facsimile apparatus to the control apparatus from the facsimile apparatus; allowing a user of the control apparatus to select one of the transmitted sender information displayed on a display section of the control apparatus; transmitting the selected sender information, and document data created or acquired in advance, to the facsimile apparatus from the control apparatus; attaching in the facsimile apparatus the sender information to a cover sheet of the document data, both received from the control apparatus; and converting in the facsimile apparatus the document data attached with the sender information to facsimile data so as to transmit the facsimile data to a predetermined sending destination.
(2) According to another aspect of the present invention, in the controlling method recited in item 1, the control apparatus sends a transmission request of the at least one sender information to the facsimile apparatus, while, in response to the transmission request, the facsimile apparatus transmits the at least one sender information to the control apparatus.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram of a configuration of a facsimile system embodied in the present invention as the first embodiment;

FIG. 2 shows a block diagram indicating a configuration of a control apparatus embodied in the present invention as the first embodiment;

FIG. 3 shows a block diagram indicating a configuration of a FAX apparatus embodied in the present invention as the first embodiment;

FIG. 4 shows a block diagram indicating internal configurations of both a controlling section of a control apparatus (PC-FAX driver) and a controlling section of a FAX apparatus, embodied in the present invention as the first embodiment;

FIG. 5 shows a flowchart indicating procedures for registering sender information, to be implemented in a facsimile system embodied in the present invention as the first embodiment;

FIG. 6 shows a flowchart indicating procedures for transmitting a facsimile document, to be implemented in a facsimile system embodied in the present invention as the first embodiment;

FIG. 7 shows an exemplary layout of a screen (sender information setting screen) to be displayed on a display section of a FAX apparatus embodied in the present invention as the first embodiment;

FIG. 8 shows an exemplary layout of another screen (sender information inputting screen) to be displayed on a display section of a FAX apparatus embodied in the present invention as the first embodiment;

FIG. 9 shows an exemplary layout of a screen (facsimile setting screen) to be displayed on a display section of a control apparatus embodied in the present invention as the first embodiment;

FIG. 10 shows an exemplary layout of another screen (facsimile setting screen) to be displayed on a display section of a control apparatus embodied in the present invention as the first embodiment;

FIG. 11 shows a block diagram indicating internal configurations of both a controlling section of a control apparatus (PC-FAX driver) and a controlling section of a FAX apparatus, embodied in the present invention as the second embodiment;

FIG. 12 shows a flowchart indicating procedures for registering sender information, to be implemented in a facsimile system embodied in the present invention as the second embodiment; and

FIG. 13 shows a flowchart indicating procedures for transmitting a facsimile document, to be implemented in a facsimile system embodied in the present invention as the second embodiment.

### DETAILED DESCRIPTION OF THE PREFERRED EMBODIMENT

As described in the “BACKGROUND OF THE INVENTION”, when attaching the sender information to the cover sheet of facsimile document to be transmitted in response to the instruction sent from the control apparatus, the sender information that is established in advance as default settings is attached to the cover sheet. Accordingly, there has been a problem that, when attaching sender information based on settings other than the default settings, it is necessary for the user to physically go to the FAX apparatus in order to change the default settings to revised settings, or otherwise, to input again the newly desired sender information by operating the operating section of the FAX apparatus, resulting in an increase of cumbersome works.

Such the problem as abovementioned possibly occurs in every system in which the control apparatus and the FAX apparatus are coupled to each other through the communication network. Specifically, in such a case that the area of the network system is wide and the control apparatus is located at a position far from the FAX apparatus, or a plurality of FAX apparatuses are coupled to each other in the same network system, the abovementioned problem has been frequently occurred.

To cope with the abovementioned problem, a control apparatus, embodied in the present invention, is provided with a function for acquiring the sender information from the FAX apparatus, and another function for displaying a list of plural sets of sender information acquired from the FAX apparatus so that the user can select a desired one of the plural sets of sender information from the list. According to this feature of the present invention, it becomes unnecessary for the user not only to change the default settings of the sender information established in advance in the FAX apparatus, but also to newly input sender information from the control apparatus, resulting in an improvement of the maneuverability of setting the sender information.

### Embodiment 1

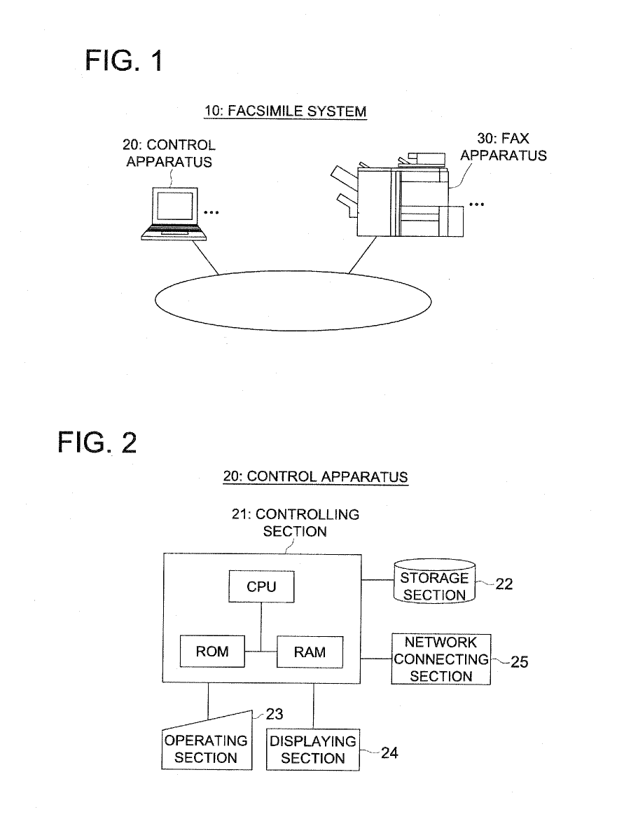

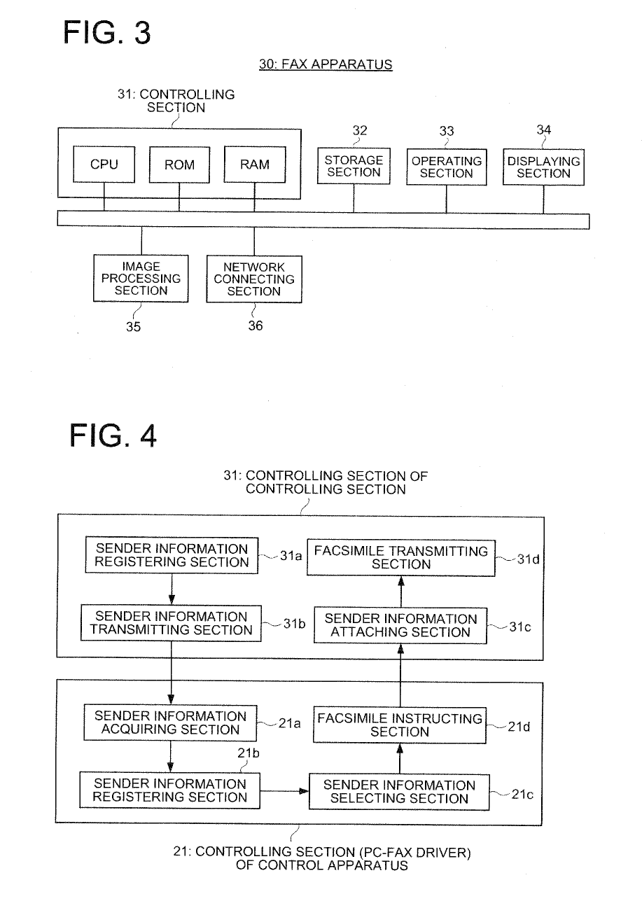

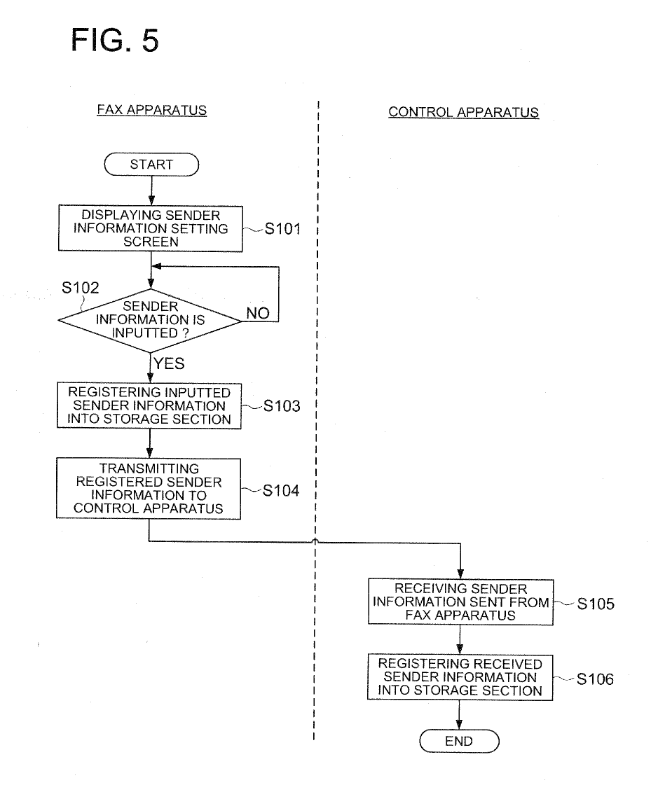

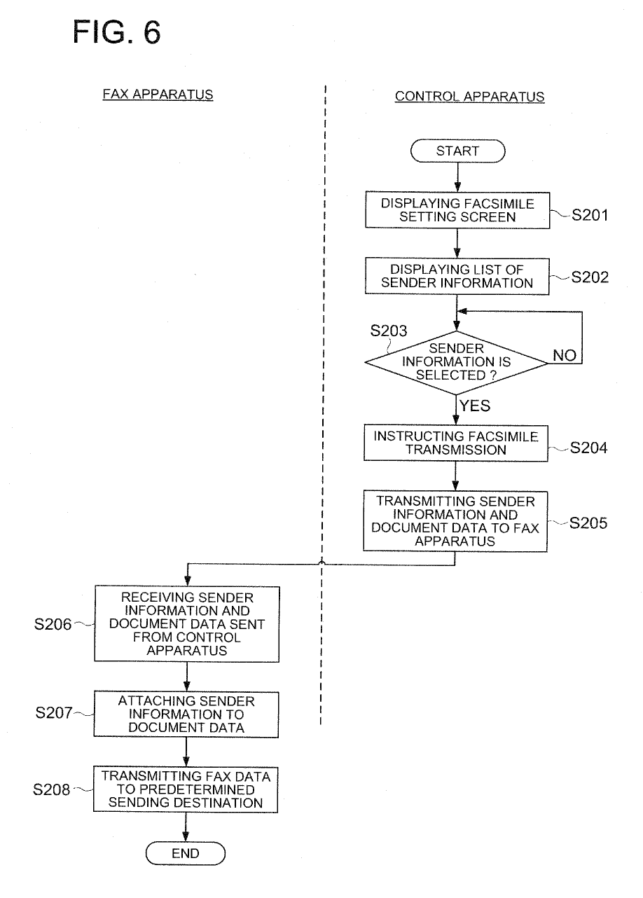

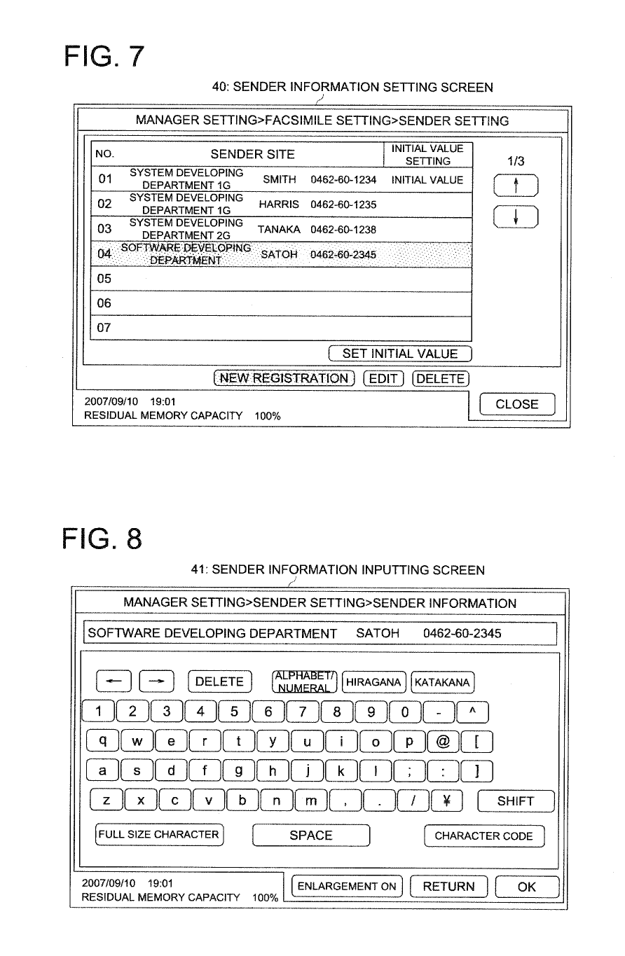

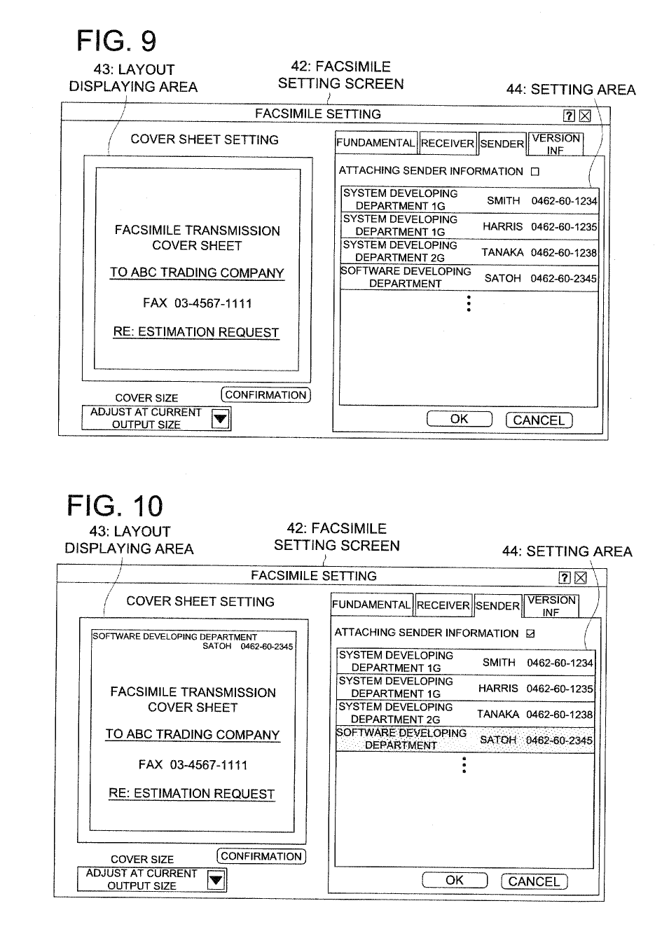

In order to describe the preferred embodiment of the present invention in detail, referring to FIG. 1 through FIG. 10, software, a control apparatus and a controlling method, embodied in the present invention as EMBODIMENT 1, will be detailed in the following. FIG. 1 shows a schematic diagram of a configuration of the facsimile system embodied in the present invention. Further, FIG. 2 shows a block diagram indicating a configuration of the control apparatus embodied in the present invention, while FIG. 3 shows a block diagram indicating a configuration of the FAX apparatus. Still further, FIG. 4 shows a block diagram indicating internal configurations of the FAX apparatus and the control apparatus, embodied in the present invention, FIG. 5 shows a flowchart indicating procedures for registering the sender information, and FIG. 6 shows a flowchart indicating procedures for transmitting a facsimile document. Yet further, FIG. 7 and FIG. 8 show exemplary layouts of screens to be displayed on the display section of the FAX apparatus, while FIG. 9 and FIG. 10 show exemplary layouts of screens to be displayed on the display section of the control apparatus.

As shown in FIG. 1, a facsimile system 10, embodied in the present invention, is provided with a single control apparatus 20 or a plurality of control apparatuses 20 to create document data by executing an application program and to instruct a facsimile transmitting operation; and a single FAX apparatus 30 or a plurality of FAX apparatuses 30 to implement the facsimile transmitting operation based on the instruction sent from the control apparatus 20, wherein the control apparatus 20 and the FAX apparatus 30 are coupled to each other through a communication network, such as a LAN (Local Area Network), a WAN (Wide Area Network), etc.

As shown in FIG. 2, the control apparatus 20 is constituted by a computer device or a computer system, such as a personal computer, a work station, etc. Further, the control apparatus 20 is provided with a controlling section 21, a storage section 22, an operating section 23, a displaying section 24, a network connecting section 25, etc., which are coupled to each other through a bus as its internal configuration.

The controlling section 21 is constituted by a CPU (Central Processing Unit), a ROM (Read Only Memory), a RAM (Random Access Memory), etc. The ROM stores programs and data for controlling the overall operations of the control apparatus 20, therein. The RAM stores data to be utilized for the controlling operations implemented by the CPU and other data to be temporarily stored, etc., therein. Accordingly, the CPU, the ROM and the RAM work together to control the overall operations of the control apparatus 20. Further, the CPU executes specific software so that the controlling section 21 implements the function for instructing the facsimile transmitting operation to the FAX apparatus 30. Hereinafter, the controlling section 21 that implements the abovementioned function is referred to as a “PC-FAX Driver”, while the specific software mentioned in the above is referred to as “PC-FAX Driver Software”.

The storage section 22 is constituted by an HDD (Hard Disc Drive), etc., so as to store application programs for creating a document, the PC-FAX Driver Software abovementioned, the sender information, etc., therein.

The displaying section 24 is constituted by a keyboard, a mouse, etc., so as to make various kinds of setting operations for facsimile transmission, an operation for selecting the sender information, etc., possible.

The displaying section 24 is constituted by a LCD (Liquid Crystal Display), etc., so as to display a facsimile setting screen for conducting various kinds of setting operations for the facsimile transmission, and to display the list of the sender information on the facsimile setting screen in a user selectable mode.

The network connecting section 25 is constituted by a NIC (Network Interface Card), a modem, etc., so as to conduct bilateral communications with the FAX apparatus 30 through the communication network.

In this connection, although the control apparatus 20 shown in FIG. 1 represents the personal computer, any kind of apparatus, for instance, a PDA (Personal Digital Assistants), a cellar phone, etc., is applicable as the control apparatus 20, as far as the apparatus concerned is capable of controlling the FAX apparatus 30.

Further, as shown in FIG. 3, the FAX apparatus 30 is constituted by a controlling section 31, a storage section 32, an operating section 33, a displaying section 34, an image processing section 35, a network connecting section 36, etc., which are coupled to each other through a bus.

The controlling section 26 is constituted by a CPU, a ROM, a RAM, etc. The ROM stores programs and data for controlling the overall operations of the FAX apparatus 30, therein. The RAM stores data to be utilized for the controlling operations implemented by the CPU and other data to be temporarily stored, etc., therein. Accordingly, the CPU, the ROM and the RAM work together to control the overall operations of the FAX apparatus 30.

The storage section 32 is constituted by an HDD (Hard Disc Drive), a flash memory, etc., so as to store various kinds of setting information, the sender information, etc., therein.

The operating section 33 is constituted by various kinds of buttons and switches, a touch panel, etc., so as to make an operation for inputting the sender information, etc., possible.

The displaying section 34 is constituted by a LCD (Liquid Crystal Display), etc., so as to display a sender information setting screen, a sender information inputting screen, etc., thereon.

The image processing section 35 parses document data acquired from the control apparatus 20 (or the data written in the PDL (Page Description Language) format, which is created from the document data by the control apparatus 20), so as to convert the document data to the data written in a bitmap format being encodable for the facsimile transmission (hereinafter, referred to as FAX data).

The network connecting section 36 is constituted by a NIG, a modem, etc., so as to conduct bilateral communications with the control apparatus 20 through the communication network. Further, the network connecting section 36 transmits FAX data to a FAX apparatus, serving as a sending destination of the FAX data concerned, through the public telephone line, etc.

In this connection, any kind of apparatus that is provided with the facsimile function is applicable as the FAX apparatus 30 embodied in the present invention as EMBODIMENT 1. For instance, it is applicable that the FAX apparatus 30 is provided with only the facsimile function, or is a multi-functional apparatus that is provided with a scanner function, a printer function, a post processing function, etc., in addition to the facsimile function.

In order to make the sender information, registered in advance in the FAX apparatus 30, selectable in the control apparatus 20, the controlling section 31 of the FAX apparatus 30 and the controlling section 21 of the control apparatus 20 (PC-FAX Driver), embodied in the present invention as EMBODIMENT 1, are configured as the block diagram shown in FIG. 4.

Concretely speaking, the controlling section 31 of the FAX apparatus 30 is provided with: a sender information registering section 31a to register the inputted sender information into the storage section 32; a sender information transmitting section 31b to transmit the registered sender information to the control apparatus 20; a sender information attaching section 31c to receive the document data and the sender information from the control apparatus 20 so as to attach the sender information to the document data; and a facsimile transmitting section 31d to transmit the FAX data, converted by the image processing section 35, through the network connecting section 36.

On the other hand, the controlling section 21 (PC-FAX Driver) of the control apparatus 20 is provided with: a sender information acquiring section 21a to acquire the sender information from the FAX apparatus 30; a sender information registering section 21b to register the acquired sender information into the storage section 22; a sender information selecting section 21c to display the list of registered sender information on the displaying section 24 in a user-selectable mode; and a facsimile instructing section 21d to transmit the document data created by executing application programs and the selected sender information to the FAX apparatus 30 so as to instruct the facsimile transmitting operation.

According to the abovementioned configuration, the sender information registering section 31a of the FAX apparatus 30 registers the sender information (including a name of section, a name of sender, a facsimile (telephone) number, etc.) to be attached to the cover sheet, into the storage section 32, while the sender information transmitting section 31b transmits the registered sender information to the controlling section 21 (PC-FAX Driver) of the control apparatus 20.

Further, the sender information acquiring section 21a, provided in the controlling section 21 (PC-FAX Driver) of the control apparatus 20, receives the sender information transmitted from the FAX apparatus 30, and the sender information registering section 21b registers the received sender information into the storage section 22. Then, the sender information selecting section 21c displays the list of the registered sender information in the user-selectable mode. Successively, the facsimile instructing section 21d transmits the selected sender information and the document data to the FAX apparatus 30, and instructs the FAX apparatus 30 to Implement the facsimile transmitting operation.

On the other hand, the sender Information attaching section 31c of the FAX apparatus 30 attaches the sender information to the document data, while the facsimile transmitting section 31d transmits the FAX data, converted by the image processing section 35, to a predetermined sending destination.

As mentioned in the above, since the sender information acquiring section 21a of the control apparatus 20 acquires the sender information from the FAX apparatus 30, and the sender information selecting section 21c displays the list of the sender information in the user-selectable mode, it becomes unnecessary for the user, not only to physically go to the FAX apparatus 30 to change the default setting of the sender information, but also to newly input the sender information at the control apparatus 20, resulting in an improvement of maneuverability for setting the sender information.

In this connection, every one of the sender information acquiring section 21a, the sender information registering section 21b, the sender information selecting section 21c and the facsimile instructing section 21d, which are provided in the control apparatus 20, can be configured as software, or at least a part of each of them can be configured as a hardware. Further, every one of the sender information registering section 31a, the sender information transmitting section 31b, the sender information attaching section 31c and the facsimile transmitting section 31d, which are provided in the FAX apparatus 30, can be configured as software, or at least a part of each of them can be configured as a hardware.

The operations to be implemented in the facsimile system 10, configured as the abovementioned, will be detailed in the following.

Initially, referring to the exemplary screen layouts shown in FIG. 7 and FIG. 8, the procedure for registering the sender information will be detailed in the following.

When the user operates the operating section 33 of the FAX apparatus 30, the controlling section 31 makes the displaying section 34 display a sender information setting screen 40 from which the user can set the sender information (Step S101). For instance, the layout of the sender information setting screen can be structured as shown in FIG. 7, so as to display the list of the sender information registered in advance. Successively, when the user depresses a button of “NEW REGISTRATION” provided on the sender information setting screen 40, the controlling section 31 makes the displaying section 34 display a sender information inputting screen 41 from which the user can input the sender information, as shown in FIG. 8. Then, when the user depresses the OK button after inputting the desired sender information, the desired sender information newly inputted by the user (Line No. 04 in FIG. 7) is added to the list of the sender information in the sender information setting screen 40.

In this connection, in the exemplary screen layouts shown in FIG. 7 and FIG. 8, each of the sender information includes the name of the section, the name of the sender and the facsimile (telephone) number. However, either an arbitral combination of the above information or an addition of information other than the above is applicable as the sender information, as far as the sender information includes such information that specifies the sender site.

Successively, when the sender information is inputted (Step S102, Yes), the sender information registering section 31a registers the inputted sender information into the RAM or the storage section 32 of the FAX apparatus 30 (Step S103). Then, the sender information transmitting section 31b transmits the registered sender information to the control apparatus 20 coupled to the network, through the network connecting section 36 (Step S104).

Still successively, the sender information acquiring section 21a of the control apparatus 20 receives the sender information sent from the sender information transmitting section 31b through the network connecting section 25 (Step S105). Then, the sender information registering section 21b registers the received sender information into the RAM or the storage section 22 (Step S106), and after that, the operation for registering the sender information is finalized (END).

In this connection, although the abovementioned system is so constituted that the sender information is transmitted to the control apparatus 20 immediately after the sender information is inputted into the FAX apparatus 30, it is also applicable that the sender information is transmitted from the FAX apparatus 30 at predetermined time intervals. Further, it is applicable that the sender information is transmitted to either all of the control apparatuses 20 coupled to the network, or only a single control apparatus 20 predetermined in advance.

Next, referring to the flowchart shown in FIG. 6 and the screen layouts shown in FIG. 9 and FIG. 10, a facsimile transmitting procedure will be detailed in the following.

Initially, when the user creates document data by using corresponding application program installed in advance into the control apparatus 20 and inputs an instruction for transmitting the created document through the facsimile by using a function of corresponding application program, the controlling section 21 (PC-FAX Driver) makes the displaying section 24 display a facsimile setting screen 42 (Step S201). For instance, as shown in FIG. 9, the facsimile setting screen 42 is provided with a layout displaying area 43 in which a layout of the cover sheet of the facsimile document is displayed and a setting area 44 in which various kinds of setting items are displayed, so that the user can set (input) information necessary for the facsimile transmission (for instance, the sender information, etc.).

Successively, when the user selects a tab titled “SENDER” in the setting area 44 of the facsimile setting screen 42, the sender information selecting section 21c displays a checkbox for setting whether or not the sender information is attached to the cover sheet, and the list of the sender information, registered in advance, within the setting area 44 (Step S202). Then, when the user checks the checkbox and selects a desired sender information from the list of the sender information, a revised layout of the cover sheet, in which the selected sender information (crosshatched one indicated in the setting area 44) is attached at a predetermined position, is displayed in the layout displaying area 43, as shown in FIG. 10 (Step S203).

In this connection, in the exemplary screen layouts shown in FIG. 9 and FIG. 10, the name of the section, the name of the sender and the facsimile (telephone) number are displayed as the sender information. However, either an arbitral combination of the above information or an addition of information other than the above is applicable as the sender information, as far as the sender information includes such information that specifies the sender site.

Still successively, when the user instructs the facsimile transmission by depressing the OK button provided in the facsimile setting screen 42 (Step S204) after selecting the desired sender information (Step S203; Yes), the facsimile instructing section 21d converts the document data to the data written in the PDL (Page Description Language), such as the PDL (Printer Control Language), the PS (PostScript), etc., and then, transmits the selected sender information and the converted document data written in the PDL, etc., to the FAX apparatus 30 through the network connecting section 25 (Step S205).

In this connection, although the system of the abovementioned EMBODIMENT 1 is so constituted that the document data created by using the application program is transmitted to the FAX apparatus 30, it is also applicable that the other document data stored in the storage section 22 or the other document data acquired from the other coupled apparatus through the communication network is transmitted to the FAX apparatus 30. Further, in the case that the document data created by using the application program is such a data file or a PDF (Portable Document Format) data file that is created in conformity with the XPS (XML Paper Specification), and the FAX apparatus 30 is provided with a direct printing function for receiving the data file written in the abovementioned format so as to conduct the printing operation based on the received data file, it is possible to omit the operation for converting the document data to the data written in the PDL. In other words, both the document data in conformity with a general purpose file format, such as the XPS, the PDF, etc., and the other document data converted to the PDL data format exclusively employed for the printing purpose, are considered as the document data to be transmitted to the FAX apparatus 30 from the control apparatus 20.

Still successively, the sender information attaching section 31c of the FAX apparatus 30 receives the sender information and the document data sent from the facsimile instructing section 21d (Step S206), and then, attaches the sender information to the document data (Step S207). Yet successively, the image processing section 35 converts the document data to the FAX data, and then, the facsimile transmitting section 31d transmits the FAX data to the predetermined sending destination through the network connecting section 36 (Step S208).

In this connection, in the flowchart shown in FIG. 6, the system is so constituted that, after transmitting the sender information and the document data to the FAX apparatus 30 so as to attach the sender information to the document data in the FAX apparatus 30, the document data is converted to the FAX data, and then, the FAX data Is transmitted through the facsimile transmitting operation. However, it is also applicable that the sender information is attached to the document data in the control apparatus 20, and then, the document data attached with the sender information is transmitted to the FAX apparatus 30.

### Embodiment 2

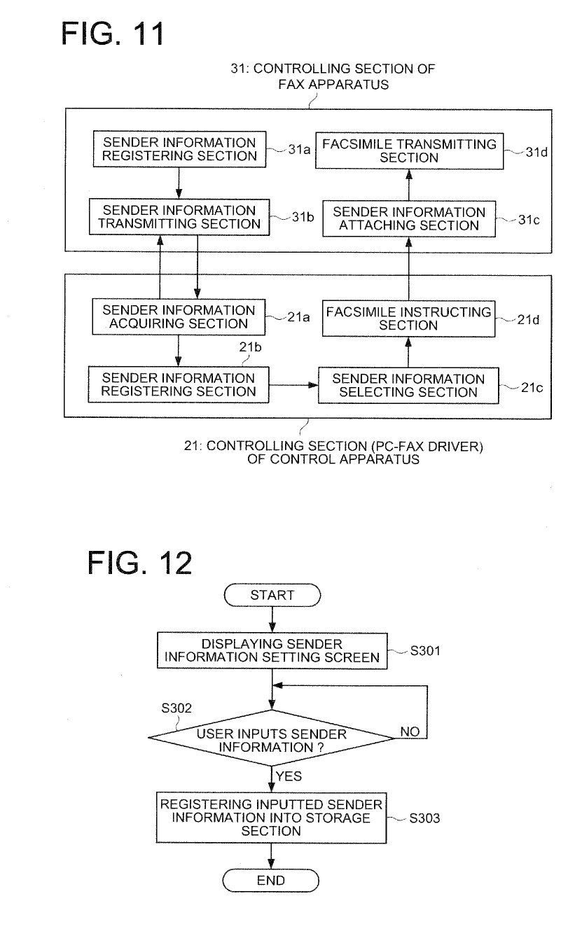

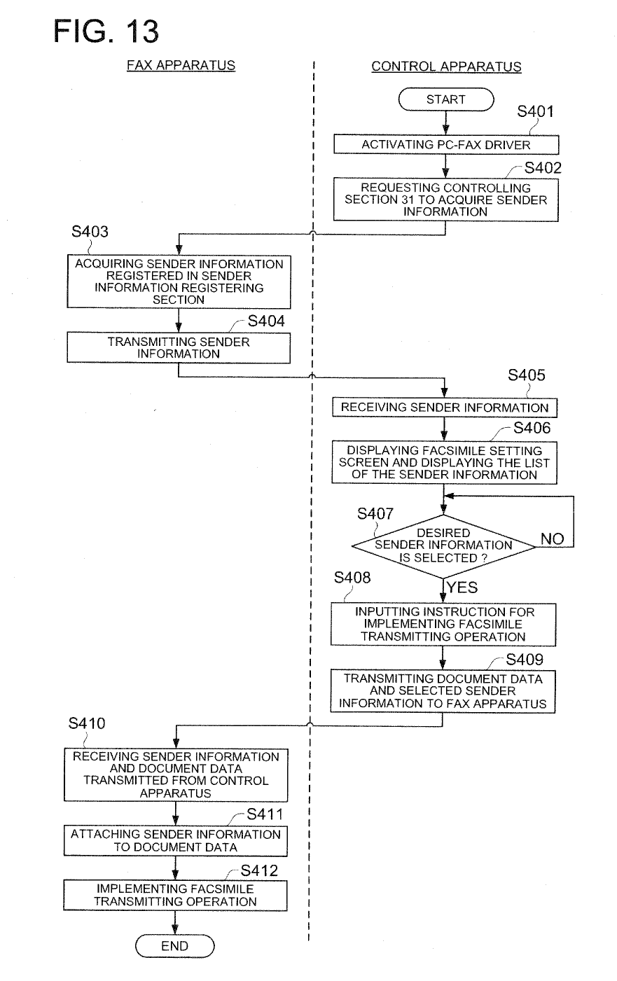

Next, referring to FIG. 11 through FIG. 13, software, a control apparatus and a controlling method, embodied in the present invention as EMBODIMENT 2, will be detailed in the following. FIG. 11 shows a block diagram indicating internal configurations of the FAX apparatus and the control apparatus, embodied in the present invention. FIG. 12 shows a flowchart indicating procedures for registering the sender information, and FIG. 13 shows a flowchart indicating procedures for transmitting a facsimile document.

Although the aforementioned system of EMBODIMENT 1 is so constituted that, when the user inputs the sender information from the FAX apparatus 30, the inputted sender information is transmitted to the control apparatus 20, it is impossible for the control apparatus 20 to receive the sender information if the power source of the control apparatus 20 is turned OFF. In addition, in the case that the plural control apparatuses 20 are coupled to the communication network, since all of the plural control apparatuses 20 do not necessarily conduct the facsimile transmitting operation, the operation for registering the sender information is not necessary for control apparatus 20 that does not conduct the facsimile transmitting operation. Accordingly, in EMBODIMENT 2, the system is so constituted that the control apparatus 20 requests the control apparatus 20 to transmit the sender information as needed, instead of unilaterally sending the sender information from the FAX apparatus 30 to the control apparatus 20.

To achieve the abovementioned feature, although the configurations of the control apparatus 20 and the FAX apparatus 30 included in the facsimile system 10 are the same as those shown in FIG. 1 through FIG. 4, as shown in FIG. 11, in response to a sender information transmitting request sent from the sender information acquiring section 21a of the control apparatus 20 to the FAX apparatus 30, the sender information transmitting section 31b of the FAX apparatus 30 conducts controlling operations for transmitting the sender information. In this connection, according to the facsimile system 10 embodied as EMBODIMENT 2, since the control apparatus 20 can acquire the sender information as needed, the sender information is not necessarily registered into the control apparatus 20. Therefore, it is possible to omit the sender information registering section 21b of the control apparatus 20.

The operations to be implemented in the facsimile system 10, configured as the abovementioned, will be detailed in the following.

Initially, referring to the exemplary screen layouts shown in FIG. 12, the procedure for registering the sender information will be detailed in the following.

As well as EMBODIMENT 1, the displaying section 34 of the FAX apparatus 30 is made to display the sender information setting screen 40 as shown in FIG. 7 and the sender information inputting screen 41 as shown in FIG. 8 (Step S301). When the user inputs the sender information (Step S302; Yes), the sender information registering section 31a registers the inputted sender information into the RAM and/or the storage section 32 (Step S303).

At this time, the registering operation is finalized just after the sender information has been registered in the RAM and/or the storage section 32 of the FAX apparatus 30, since the sender information is transmitted in response to the acquiring request sent from the control apparatus 20 in the facsimile system 10 of EMBODIMENT 2, though the FAX apparatus 30 transmits the sender information to the control apparatus 20 in the facsimile system 10 of EMBODIMENT 1 aforementioned

Next, referring to the flowchart shown in FIG. 13, the procedure for transmitting the facsimile document will be detailed in the following.

Initially, when the user creates document data by using corresponding application program installed in advance into the control apparatus 20 and inputs an instruction for transmitting the created document through the facsimile by using a function of corresponding application program, the controlling section 21 activates the software of the PC-FAX Driver to start the function as the PC-FAX Driver (Step S401). Then, the sender information acquiring section 21a requests the controlling section 31 of the FAX apparatus 30 (for instance, sender information transmitting section 31b) to acquire the sender information (Step S402).

Successively, in response to the acquiring request sent from the sender information acquiring section 21a, the controlling section 31 of the FAX apparatus 30 (sender information transmitting section 31b) acquires the sender information registered in the sender information registering section 31a therefrom (Step S403), and then, transmits the acquired sender information to the sender information acquiring section 21a (Step S404).

Still successively, the sender information acquiring section 21a receives the sender information transmitted from the FAX apparatus 30, and the sender information registering section 21b registers the received sender information into the RAM and/or the storage section 22 (Step S405). In this connection, in EMBODIMENT 2, since the sender information is acquired at the time of the facsimile transmitting operation, the received sender information is not necessary registered into the RAM and/or the storage section 22.

Still successively, the sender information selecting section 21c makes the displaying section 24 display the facsimile setting screen 42 as shown in FIG. 9, and when the tab of “SENDER” is selected, the sender information selecting section 21c makes the displaying section 24 display the list of the sender information in the setting area 44 (Step S406).

Still successively, after the user checks the checkbox and selects the desired sender information from the list of the sender information (Step S407; Yes), the user inputs the instruction for implementing the facsimile transmitting operation by depressing the OK button located in the facsimile setting screen 42 shown in FIG. 9 (Step S408). Then the facsimile instructing section 21d transmits the selected sender information, the document data, etc., to the FAX apparatus 30 through the network connecting section 25 (Step S409).

Yet successively, the sender information attaching section 31c of the FAX apparatus 30 receives the sender information and the document data transmitted from the facsimile instructing section 21d (Step S410), and attaches the sender information to the document data (Step S411). Then, after the document data is converted to the FAX data in the image processing section 35, the facsimile transmitting section 31d transmits the FAX data to the predetermined sending destination through the network connecting section 36 (Step S412).

In this connection, in the flowchart shown in FIG. 13, the system is so constituted that the control apparatus 20 requests the FAX apparatus 30 to acquire the sender information, and in response to the above acquiring request, the FAX apparatus 30 sends the sender information to the control apparatus 20. However, it is also applicable that the control apparatus 20 accesses the FAX apparatus 30 so as to directly take out the sender information from the storage section 32 of the FAX apparatus 30. Further, although the system in the flowchart shown in FIG. 13 is so constituted that, after creating the document data by employing corresponding application program, the control apparatus 20 requests the FAX apparatus 30 to acquire the sender information, it is also applicable that, after acquiring the sender information, the document data is created. Still further, although the sender information is attached to the document data in the FAX apparatus 30 in the flowchart shown in FIG. 13, it is also applicable that the sender information is attached to the document data in the control apparatus 20, and then, the document data attached with the sender information is transmitted to the FAX apparatus 30.

Further, in each of the configurations of EMBODIMENT 1 and EMBODIMENT 2, described in the foregoing, the controlling section 21 (PC-FAX Driver) of the control apparatus 20 is provided with the sender information acquiring section 21a, the sender information registering section 21b, the sender information selecting section 21c and the facsimile instructing section 21d, while the controlling section 31 of the FAX apparatus 30 is provided with the sender information registering section 31a, the sender information transmitting section 31b, the sender information attaching section 31c and the facsimile transmitting section 31d. However, the scope of the present invention is not limited to the abovementioned EMBODIMENT 1 and EMBODIMENT 2, but it is applicable in the present invention that the control apparatus 20 is provided with at least the sender information acquiring section 21a and the sender information selecting section 21c in configuration of either hardware or software.

The present invention is available for software, a control apparatus, a controlling method to be operated in a control apparatus for controlling the FAX apparatus.

According to the software, the control apparatus and the controlling method embodied in the present invention, it becomes possible for the user to improve the maneuverability of the operations for setting the sender information.

This is because, since the control apparatus (or the software) acquires the sender information from the FAX apparatus, and controls the display section display a list of the sender information in a user-selectable mode, by registering the sender information into the FAX apparatus only, it becomes possible for the user to transmit the facsimile document attached with the sender information only by conducting such a simple operation for selecting the desired sender information from the list, without inputting again the sender information from the control apparatus.

While the preferred embodiments of the present invention have been described using specific term, such description is for illustrative purpose only, and it is to be understood that changes and variations may be made without departing from the spirit and scope of the appended claims.

What is claimed is:

1. A computer readable storage medium storing a computer executable program for implementing operations to be conducted by a control apparatus that is coupled to a facsimile apparatus through a communication line so as to instruct the facsimile apparatus to conduct a facsimile transmitting operation, the program being executable by a computer to cause the computer to perform a process comprising:
acquiring at least one set of sender information, each of which is information about a sender and is registered in the facsimile apparatus in advance, from the facsimile apparatus; and
allowing a user to select one of the acquired sender information displayed on a display section of the control apparatus.

2. The computer readable storage medium of claim 1,
wherein the process further comprises:
making a storage section of the control apparatus store the sender information acquired from the facsimile apparatus; and
transmitting the selected sender information, and document data created or acquired in advance, to the facsimile apparatus from the control apparatus.

3. The computer readable storage medium of claim 1,
wherein the process further comprises:
requesting the facsimile apparatus to transmit the at least one set of sender information.

4. A control apparatus that is coupled to a facsimile apparatus through a communication line so as to instruct the facsimile apparatus to conduct a facsimile transmitting operation, the control apparatus comprising:
a sender information acquiring section to acquire from the facsimile apparatus at least one set of sender information, each of which is information about a sender and is registered in the facsimile apparatus in advance; and
a sender information selecting section to allow a user to select one of the acquired sender information displayed on a display section.

5. The control apparatus of claim 4, further comprising:
a sender information registering section to make a storage section store the sender information acquired from the facsimile apparatus; and
a facsimile instructing section to transmit the selected sender information, and document data created or acquired in advance, to the facsimile apparatus.

6. The control apparatus of claim 4,
wherein the sender information acquiring section requests the facsimile apparatus to transmit the at least one set of sender information.

7. A controlling method to be employed in such a system that includes a facsimile apparatus and a control apparatus for instructing the facsimile apparatus to conduct a facsimile transmitting operation, which are coupled to each other through a communication network, the controlling method comprising:
registering at least one set of sender information into the facsimile apparatus, each set of the sender information being information about a sender;
transmitting the at least one set of sender information registered in the facsimile apparatus to the control apparatus from the facsimile apparatus;
allowing a user of the control apparatus to select one of the transmitted sender information displayed in a display section of the control apparatus;
transmitting the selected sender information, and document data created or acquired in advance, to the facsimile apparatus from the control apparatus;
attaching in the facsimile apparatus the sender information to a cover sheet of the document data, both received from the control apparatus; and
converting in the facsimile apparatus the document data attached with the sender information to facsimile data so as to transmit the facsimile data to a predetermined sending destination.

8. The controlling method of claim 7,
wherein the control apparatus sends a transmission request of the at least one set of sender information to the facsimile apparatus, while, in response to the transmission request, the facsimile apparatus transmits the at least one set of sender information to the control apparatus.
